(19) United States
(12) Patent Application Publication
(10) Pub. No.: US 2019/0210283 A1
(43) Pub. Date: Jul. 11, 2019

(54) Bioprinter design and applications

(71) Applicant: Richard Rouse, San Diego, CA (US)

(72) Inventor: Richard Rouse, SAN DIEGO, CA (US)

(73) Assignee: Richard Rouse, SAN DIEGO, CA (US)

(21) Appl. No.: 15/901,889

(22) Filed: Feb. 22, 2018

Related U.S. Application Data
(60) Provisional application No. 62/462,484, filed on Feb. 23, 2017.

(51) Int. Cl. B29C 64/227; B33Y 30/00; B33Y 50/02; B29C 64/209; B29C 64/393

(52) U.S. Cl. CPC B29C 64/227; B33Y 30/00; B29C 64/393; B29C 64/209; B33Y 50/02

(57) ABSTRACT

Enclosed is a description of a high throughput 3D printing and imaging system that can be used for multiple laboratory purposes from bioassay fabrication to analysis. This compact system is designed to work with multiple microwell plates and slides. It also contains linear encoders for precise positional control in the XYZ direction. A syringe pump and 3 way select valve configuration and interrelated microfluidics are described and compact stepper motor driven linear actuators for moving tools on the gantry head is also explained. In addition, there is a visualization and sorting area for measuring droplets and for deflecting charged particles magnetized collection tubes. There is also an imaging module for quantifying fluorescence abundance and an analog signal triggered camera that can be synchronized with dispensers that can be used for synchronized imaging and data collection.

### BACKGROUND OF INVENTION

The purpose of the described invention is to describe a general purpose laboratory automation platform that can be used for a variety of biotechnological processes so that it can be reconfigured as application requirements change in the laboratory. It addresses an unmet need where in the current market instruments designed to a specific task such as liquid handling or imaging. Typically this type of hardware is very expensive requiring a service contract to maintain over time. The electronics, hardware and software are proprietary to the manufacturer which forces to the consumer to be dependent on the manufacturers support. Given the exclusivity, the manufacturer can and does drive the cost up which eventually is passed on to the consumer which factors into the high healthcare costs in the US market.

The described invention is designed for configuring an open infrastructure for the end user to customize features. The concept is based on open source 3D printer fused deposition manufacturing (FDM), many examples of which are described on the Reprap website (http://www.reprap.org). The hardware parts can be fabricated using this 3D printer and the 3D CAD drawings which have been designed using open source CAD drawing software (Openscad—www.openscad.org).

Creating a general purpose laboratory instrument based on a 3D printer design is not trivial. First there are many 3D printer designs to choose from. 3D printers can be Cartesian (linear X, Y and Z directional motion) or non Cartesian (delta, polar or robot arm). Cartesian systems are more compact, flexible and configurable for designing biotech processes. For most of these Cartesian open source 3D printers, the printing bcd moves back and forth (in the Y direction) and the plastic extruder moves up and down (in the Z direction) and right and left (in the X direction). This is not practical for biotech related lab automation since the printing targets movement can adversely affect the accuracy of the manufacturing process. Also the system needs to be adaptable to handle high throughput processes. So described is a compact Cartesian robotic platform that includes a conveyor component for loading a plurality of removable printing targets.

This system is designed to handle a diverse array of fabrication processes. It can do piezoelectric based dispensing which involves using an piezoelectric dispenser that is actuated using an amplified waveform (ie., 50-150 volts, pulse width range (10 to 200 microseconds) and frequency 1 to 1000 drops per second) allowing for picoliter or nanoliter dispensing. Also described is a syringe pump module and a 3 way valve and within this tool it is possible to do microliter scale liquid handling (aspiration and dispense) using a displaced volume process. But in addition to liquid handing, the same system can do 3D printing using FDM by putting on a conventional thermoplastic FDM extruder which is commonly known in the Reprap community (ie., Bowden Extruder). This can be used to make devices that can be used in experiments or for building other robotics.

In addition to fabrication, the system also is designed to work with various imaging techniques. One of which commonly used to facilitate the fabrication process when using piezoelectric dispensers, is a stroboscope that is a synchronized illumination device with the piezoelectric dispenser. This module can also be set up to particle separation since if you use an illumination device and samples are labeled with a fluorescence dye (ie., antibody labeling), upon excitation from the light source, the particle can become electrically charged and its flow can be deflected into a magnetized chamber. Also having techniques to precisely view droplets as it hits the dispensed target is very useful to assure that that the fabrication process is still working and this can set up by synchronizing analog trigger to get the camera to take a picture with the electrics associated with dispensing a droplet. Fluorescence imaging is a very convenient tool for visualization of biomolecular interactions so also there are descriptions to show how this platform can be used at a high resolution (<10 micrometer per pixel) fluorescence imager.

With these tools available on this platform it is possible to make parts for using FDM, fabrication of microarrays for bioassays, 3D print tissues, sample preparation (i.e., sorting cells) and data collection (3D scanning, fluorescence imaging and droplet analysis). It is designed as an open source ecosystem where labs can operate sophisticated laboratory procedures, share operating procedures with colleagues using a low cost, flexible robotic platform.

### DETAILED DESCRIPTION OF INVENTION

The described invention consists of a robotic XYZ system for imaging, dispensing liquids and 3D printing. FIG. 1 is an illustration of outside view of the system enclosure. Positioned on the outside of the enclosure are a syringe pump module, tubing and a pressure compensation vessel that is used to control the liquid level in dispensing nozzles (not diagrammed in this figure).

The syringe pump module is designed to work with different sizes of disposable syringes. The assembly is set up to conveniently remove the syringes so that they can be replaced. Diagrammed in FIG. 2 is an expanded view of a syringe pump module. In order to move the syringe plunger up and down to aspirate or dispense fluid, shown in FIG. 2 is a stepper motor 101, traveling nut assembly 102, threaded rod 106, linear slide rail 105, linear slide assembly 103, plunger connection 104, front syringe mount 109 and back syringe mount 108 that keep the syringe fixed as the syringe plunger moves. The motor 101 and linear slide rail 105 are positioned using a syringe pump plate (201 in FIG. 3) that is connected to the extrusion support 107, an example of which shown this diagram is a 20 mm sized T-Slot aluminum extrusion (Aluminum extrusion 5 series, Misumi USA). it can be contemplated by one skilled in the art to use other size extrusions.

The syringe pump plate 201 that supports the motor 101, plunger connection 104 and linear slide rail 105 are connected to the extrusion using one or a plurality of screws and T-Slot nuts, shown in FIG. 3C. This makes it convenient to move the the motor 101 and linear slide rail 105 to work with different size syringes. Additionally illustrated in FIG. 2, the syringe mounts 105 and 108 are also connected to the extrusion support 107 using one or a plurality of screws and T-Slot nuts and this too can be adjusted to work with different size syringes. The back syringe mount 108 contains a grooved recess that allows for the syringe to tightly fit into position. This mount can be modified to work with different sized syringes. The front syringe mount also has a circular recess and a hole large enough for the syringe orifice to go through. The syringe is securely fixed into position when the mounts 105, 108 are pushed against each other along the extrusion support 107 with sufficient force before fastening the T-Slot nut screws.

One embodiment diagrammed in FIG. 3 illustrates how the syringe pump motor assembly and syringe plunger connection are put together. The syringe pump plate 201 has a stepper motor mount 202 and holes for attaching the linear slide rail 105 with screws. In one example of the present invention, the linear slide rail 105 is manufactured by Igus called a DRYLIN T RAIL, TS-04-12. The carriage also manufactured by Igus called a DRYLIN T CARRIAGE, TW-04-12 (Igus, East Providence, USA). A linear slide carriage 203 slides along the rail 105 and has screw holes for attaching a carriage connection plate 204 (FIG. 3B). The connection plate 204 has holes for connecting a threaded nut coupler 205 and a syringe plunger clip 206 using screws.

FIG. 2 illustrates how the syringe is connected to the valve assembly 110 using tubing. The valve assembly consists of a servo motor 111, connection plate 112 and valve mount 113. The connection plate 112 attaches to the extrusion support 107 using T-Slot nuts.

In one aspect of the present invention the valve can be a three way valve 150 (FIG. 2). where it can be put into 3 different positions. One position is directing fluid flow from the syringe to a dispense nozzle (not shown). For example the dispense nozzle can be a piezoelectric pipette, solenoid dispenser, dispense capillary or a disposable pipette tip. The dispense nozzles can be positioned on the XYZ gantry head. A second valve position can direct fluid from the nozzle to a pressure compensation vessel. In one operative example, the valve is positioned to open the fluid flow to the pressure compensation vessel where fluid is drawn in the syringe. Then the valve position is changed to direct fluid flow to the dispensing nozzle and fluid flows from the syringe to the dispensing nozzle. In another aspect, fluid can be aspirated from the dispensing nozzle using the syringe. In another aspect of the present invention, air can be aspirated and dispensed using the syringe instead of fluid. A third valve position that can be used that closes fluid flow to the pressure compensation vessel and the dispensing nozzle is called the bypass position.

The syringe plunger moves up and down using the stepper motor 101 where the attached threaded rod 106 turns in one direction causing the syringe plunger to move up and in an other direction causing the syringe plunger to move down (FIG. 2). The threaded rod can be attached to the stepper motor using a flexible shaft coupler (not diagrammed). In another embodiment the threaded rod can be the stepper motor axis (Stepper Motor with 38 cm Lead Screw, Pololu Inc., Las Vegas, Nev. USA). The linear slide assembly is attached a slider carriage by means of screws.

FIG. 4 illustrates how the syringe pump valve is assembled. In FIG. 4A, The valve uses a servo motor and a stop cock valve. An example of a servo 401 can be the TowerPro SG-5010 (TowerPro, Taiwan) and a stop cock valve 402 is BD Connecta, REF 394910 (Becton Dickinson Infusion Therapy AB, Helsingborg Sweden). The servo 401 is attached 140 to a connection plate 403 which is used to attach to the extrusion support. The servo horn 404 is attached to a bottom valve connector 405 using screws. The valve connector 405 has recessed areas that are shaped to tightly fit the stop cock valve handle 406, FIG. 4B. It can be contemplated by one skilled that this shaped recessed area can be adjusted to fit other types of stop cock valves.

FIG. 4C and 4D diagrams the top valve connector 407 which has also a shaped recess area for tightly fitting the stop cock valve tubing connections 408. This is used to hold the tubing connections in place as the servo turns the stopcock handle. This is shown in FIG. 4E where the top valve connector is connected to the top valve connector support 409 which is connected to the connection plate 403.

FIG. 5 illustrates the gantry assembly. The gantry allows for movement in the X, Y and Z direction. For the X and Y direction, the system follows the CoreXY robotic motion. Where there are 2 CoreXY motors 504, it can be contemplated by one skilled in the art how CoreXY motion works since many 3D printers now use this. The system is designed to have accurate closed loop feedback by using positional encoders. In FIG. 5, diagrammed there is a y encoder 505, x encoder 1406 and also not diagrammed in FIG. 5 but shown in FIG. 6C there is a z encoder assembly 704 and in FIG. 8B there is a linear actuator encoder strip 802. One example, encoder strips are SoftPot ribbon sensors (Spectra Symbol, West Valley City, Utah). They are attached to an T-Slot extrusion support beams. The positions can be monitored using a wiper that drags along the encoder strip when there is movement, an example of which is a Spectra Symbol SoftPot wiper (Spectra symbol, West Valley City, Utah).

The Z directional movement is possible by moving the support bed 501 up and down using the Z bed motor assemblies 502. FIG. 6A, B and C shows a more expanded view of how the Z bed motor assemblies 502 move the support bed 501. Shown in FIG. 6B, there are smooth rod supports 701 on either side of the Z motor assembly 502. In one embodiment, the smooth rods are 8 mm in diameter but it can be contemplated by one skilled that a larger diameter rod can be used (ie., 12 mm). FIG. 6C shows the z motor assembly where the motor mount, motor and threaded rod are attached to an extrusion support beam. Next to the z motor assembly is a z linear encoder assembly 704. This is used to monitor the position of the support bed 501. The sensor is attached to an extrusion support beam. The position can be monitored when a 705 wiper attached to the support bed 501 is dragged along the linear encoder ribbon sensor strip 706 diagrammed in FIG. 6D.

Also attached to the support bed 501 are smooth rod bearings holders 703 and a z threaded nut holder 702 shown in FIG. 6B. In one embodiment the smooth rod bearings holders 703 hold Im8uu bearings (Adafruit Inc, New York, N.Y.) and there are 2 of these bearings per holder. The threaded rod can be a trapezoidal metric thread 8 mm. The threaded rod can be in the shaft of the stepper motor or be coupled to the motor shaft using a flexible shaft coupler (Pololu, Inc, Las Vegas, Nev.). In one preferred embodiment, the z threaded nut holder 702 has two traveling nuts with a compression spring in between to reduce backlash. The smooth rod supports 701, smooth rod bearings holder 702, z threaded nut holder 703, threaded rod 702 and z motor assembly 502 are on either side of the support bed 501. This is illustrated in 6A where there is a left z motor assembly 707 and a right z motor assembly 708. The left and right motors are attached to the same stepper motor driver and turn at the same time when programmed to do so.

In an preferred embodiment diagrammed in FIG. 7-10, is a linear actuator assembly that allows z directional movement of tools like dispensing nozzles using a linear actuator positioned on the gantry head 502. The motivation behind this embodiment is to use some of the same parts from the thermoplastic extrusion process for moving small tools up and down.

FIG. 7 illustrates part of the assembly that relates to the linear actuator module positioned on the X directional gantry head that rolls along the X directional support rail 7705. FIG. 7A diagrams assembly of the back slider plate 7701, wheels 7702 and front slider plate 7703 where these parts are positioned together, In one embodiment, the front slider plate 7703 and the back slider plate 7701 are composed of a rigid metal such as milled aluminum. FIG. 7B diagrams the front plate 7704 positioned on top of the front slider plate 7703. This assembly rolls using the wheels 7702 along an x extrusion rail 7705. FIG. 7C diagrams a linear actuator support plate 7706 which is screwed into the front plate 7704. Also a shuttle extrusion 7707 is attached to the back slider plate 7701. A timing x belt 7708 is clamped to the front plate 7704 using an x belt clamp 7709. A linear actuator slider 7710 (ie, Igus TS-04-09) is attached to the linear actuator support plate 7706 and a linear actuator carriage 7711 (ie., Igus TW-04-09) slides along it.

FIG. 7D illustrates how a linear actuator slider plate 7713 is connected to the linear actuator carriage 7711. The slider plate 7713 and carriage 7711 move up and down when connected to a cable 7714 which is clamped onto the top of the slider plate 7713 using a cable clamp 7715. The cable 7714 is connected to an extruder module diagrammed in FIGS. 8 and 9. This cable is connected to the extruder module through a PTFE bowden extruder tube 7716. In one embodiment the extruder tube can be a 4 mm outer diameter tube. The extruder tube is connected to the linear actuator support plate 7706 using a pneumatic connector 7717 (FIG. 7C and 7D). The extruder tube is also illustrated in FIG. 5 and it is used also as a guide for connecting other tubing and wires to control the devices residing on the gantry head.

FIG. 8 illustrates how the other side of the linear actuator cable 7714 (illustrated in FIG. 7) is clamped down to another linear actuator slide assembly that functions with a position encoder and an end stop which is used calibrating its position. Diagrammed in FIG. 8A, this assembly begins with a linear actuator slide plate 801 which is positioned on an extruder support and in FIG. 8B shows where the linear encoder strip 802, linear guide 803 and carriage 804 are positioned. FIG. 8C illustrates a linear actuator driver shuttle plate 805 which is connected to the cable 7714. The shuttle plate 805 is connected to the carriage 804 and on the top of the plate 805 is area for the cable 7714 to be clamped down using a cable clamp 806. The shuttle plate also has an area for positioning an encoder strip wiper and also the bottom of the shuttle plate extends sufficiently to touch a mechanical end stop which is connected to an end stop mount 809. In one embodiment the cable 7714 can be 1.75 mm diameter polylactic acid filament (PLA) composed 3D printing filament. Or it can be another 3D printing filament composition including but not limited to ABS, PET, HIPS, nylon and polypropylene. It is obvious to one skilled that the cable can be also rigid metal and the planetary gear wheel 904 (FIG. 9C) could be a rubber wheel instead.

The motor assembly for moving the cable 7714 up and down is described in FIG. 9. The motor assembly is similar to what is used in a 3D printing filament extruder. The motor is connected to an extruder support using an extruder support motor mount 901, FIG. 9A. FIG. 9B illustrates the motor positioned on the motor mount 901 and FIG. 9C illustrates an extruder module 903 positioned on the other side of the motor mount 901 from the motor 902. The module 903, mount 901 and motor 902 are connected together using screws. The extruder module is a 3D printing extruder that has a planetary gear wheel 904 attached to the motor 902 shaft. In another embodiment the planetary gear wheel 904 would be a smooth rubber wheel. It can be contemplated by one skilled in the art to know what an extruder module is. For example it could be RepRap 3D printing extruder module which are widely available (such as a Bowden extruder, delta 3d printer remote extruder). When the gear wheel turns in a clockwise direction the cable 7714 moves up which causes the linear actuator slide plate 7713 to move down (FIG. 7D) and the linear actuator driver shuttle plate 805 (FIG. 8C) to move up. The linear actuators can move to a homing position when the gear wheel turns in a counter clockwise direction to a sufficient extent where the linear actuator driver shuttle plate 805 touches the end stop 808 (FIG. 8C). FIG. 10 illustrates the extruder motor mount and the extruder linear actuator driver assembly where the motor mount is positioned above the driver assembly. The keeps the cable from bending when positioned inside a PTFE Bowden tube.

In a preferred embodiment and for increasing the throughput, there is a multiple plate loader diagrammed in FIG. 11-13. Plates (conveyor bed assemblies 1102 FIG. 11) are loaded onto the support bed 501 (also illustrated in FIG. 5) which moves in the Z direction to a position where the plates can be rolled onto it. This is possible because of an extrusion guide 1101 that is fixed on the support bed 501. The process is FIG. 11A shows where the support bed is positioned below the conveyor bed assemblies 1102. To load a specific conveyor plate assembly 1102, the support bed will move to a sufficient z height position where the extrusion guide 1101 is at the same z position as a conveyor guide 1201 (FIG. 12B) diagrammed in FIG. 11B. When the extrusion guide 1101 and conveyor guide 1201 are at the same z height, the conveyor bed 1103 moves onto the support bed 501 by rolling from the conveyor guide 1201 to the extrusion guide 1101, shown FIG. 11C. In one embodiment, the conveyor bed 1103 can be more securely fixed into position using a magnet where one pole is positioned on the conveyor bed 1103 or on the conveyor bed shuttle 1209 (FIG. 12C) and the other magnetic pole is on the support bed 501. In another embodiment, the conveyor bed 1103 can be more securely fixed into position using a lead screw press clamp or lead screw mounting bracket where either the conveyor bed 1103 or the conveyor bed shuttle 1209 can include an area that can be clamped down.

After the conveyor bed 1103 rolls into the support bed 501, the support bed 501 with the attached conveyor bed 1103 moves up to a z height where spotting targets (FIG. 11D) on the conveyor can be dispensed on by printing tools positioned on the gantry head (not shown in the figure) or alternatively imaged by images sensors positioned on the gantry head (diagrammed in FIG. 14A).

FIG. 12 is a more detailed view of the conveyor bed assembly. This consists of a conveyor bed 1103 that has holes for attaching an attach arm 1202 by screws. The attach arm has a hole having a sufficient size for a solenoid pin from a solenoid in a solenoid assembly 1203. The solenoid assembly 1203 is connected to a conveyor shuttle 1204. The conveyor shuttle 1204 consists of a traveling nut that moves along a threaded rod 1205 (FIG. 12B) which is connected to a conveyor motor assembly 1206. The rod 1205 can be connected to the conveyor motor assembly 1206 motor shaft using a motor shaft coupler 1207 or in a preferred embodiment the threaded rod is the motor shaft. The conveyor shuttle includes a connected wheel that moves along the conveyor guide extrusion as the threaded rod turns. The conveyor motor assembly 1206 consists of a motor and a motor mount plate.

When moving the conveyor bed 1103, the solenoid pin is charged sufficiently to cause the solenoid pin to go into the hole positioned on the attach arm 1202. When not moving the support bed but while moving the conveyor shuttle 1204, the solenoid is charged sufficiently to cause the solenoid pin to retract out the attach arm 1202 hole. To calibrate the conveyor shuttle 1204 position there is an end stop mount 1208 for fixing a mechanical end stop which the shuttle 1204 can touch. It is obvious to one skilled that another type of end stop switch can be used (optical, magnetic).

FIG. 12C illustrates how the conveyor bed 1103 moves along the conveyor guide 1201. The bed 1103 is fixed to a conveyor bed shuttle 1209 which consists of a plate and wheels that roll along the conveyor guide 1201 extrusions. The opposing end of the thread rod 1205 from the motor assembly 1206 is connected to a support bearing assembly 1210 that includes a bearing that turns when the rod turns. The conveyor bed also includes an attach arm opening 1211 that allows the conveyor bed 1103 when positioned on the support bed 501 to move in the z direction without the attach arm 1202 hitting the other conveyor beds.

This is a general purpose laboratory instrument designed to perform fabrication, analysis and sample preparation. Some of the features used to accomplish this are diagrammed in illustrated in FIG. 13-15. FIG. 13A diagrams devices positioned on the support bed 501. The support bed 501 has a wash station 1301 for washing and drying dispensing tools. The bed 501 has a sample plate 1302 location where dispensing tools can aspirate small volumes of samples for dispensing on target areas. This can be used for many common laboratory automation processes like microarraying onto slides, mother daughter plate replication.

The support bed 501 also has a droplet analyzer 1303 station. The droplet analyzer consists of an image sensor and a strobe light source such as an light emitting diode (LED). It can be contemplated by one skilled in the art that the strobe light can be turned on at a specified defined time after the dispensing trigger. It makes it possible to capture the droplet in flight shown in FIG. 13D. FIG. 13B diagrams a strobe light device where the light source (strobe LED 1304) is positioned on the same side of the image sensor viewing area 1305 but at an angle where the light is reflected by an angled mirror 1306 to illuminate the droplet which is possible when the dispenser is positioned above the dispensing area 1307. In another embodiment, the angled mirror is not necessary, rather the LED can be in its position and positioned directly on the other side of the image sensor or an angle. The dispense area 1307 is open so the droplets pass through so that they can be collected in collection tubes 1308 illustrated in FIG. 13C. Also illustrated in FIG. 13C are collection tubes 1308 and an magnetic holder 1309.

In a preferred embodiment, is to use the described invention to sort particles. Particles such as cells can be fluorescence labeled and upon energy excitation using a light source like an LED 1304 that emits energy at a defined wavelength the particle becomes charged (for example the particle becomes positively charged). The charged particle can be deflected into one of the specified collection tubes 1308 using a magnet. In this example the dispenser can be a piezoelectric pipette (for example Nano-Tip GeSiM GmbH, Dresden Germany) which is actuated using an amplified analog wave having a voltage range from 50-150V. The waveform can be generated using a microcontroller having a digital-to-analog converter (DAC) such has a Teensy 3.2 microcontroller (PJRC, Sherwood, Oreg. USA) which is amplified using an op-amp amplifier. The amplified wave can be triggered with an analog signal that controls the LED. For example the LED can be controlled using a power MOSFET transistor that is controlled by a pulse width modulating (PWM) signal. The LED can be turned on when the PWM signal is amplified and turn off when turning off the PWM pin. The LED can be precisely turned on within microseconds after the DAC signal using for actuating the dispenser. While the LED is turning on for a short duration, it can run with a high voltage (approx 12V) and emit light at a sufficiently high enough energy to charge a fluorescence labeled particle.

In addition to using the stroboscope as a sample prep particle sorting tool, it can also be used for sample analysis. In one embodiment, the image sensor can be a camera that generates images of the droplet. There can be a wavelength band pass filter in front of the image sensor that allows the fluorescence emitted energy after excitation from the strobe light source. From the image the droplet size and signal intensity can be measured. In another embodiment, a light sensor can be used in addition or as an alternative to a camera. In this embodiment the light can be a photodiode, that collects light at a defined time after excitation from the strobe light source. Like the above mentioned example with the camera, the photodiode can also have a wavelength band passing filter to only detect emitted light energy from the excited fluorescence.

In addition to the stroboscope, another embodiment of the present invention is to have camera and a light source mounted on the camera head. In a preferred embodiment the camera and light source can be used for quantifying fluorescence. This is illustrated in FIG. 14 that describes a gantry head having a camera mount 1401, pivot points 1402 and camera case 1403. The camera mount 1401 is positioned on the shuttle extrusion 7707 (also illustrated on FIG. 7C). The camera case 1403 is attached to the camera mount 1401 using camera arms 1404. The camera case 1403 can be moved at different angles to visualize targets using pivot points 1402. In addition to the camera, the gantry head can also be used to position light sources. Also in FIG. 14A, a laser assembly is illustrated where the laser assembly consists of a laser module and a laser module mount. It can be contemplated by one skilled in the art, that there are many ways to position the laser and it can be positioned at a sufficient angle to illuminate the camera visualization area. In this example, the laser mount is connected to a round ball that has a screw hole and a grooved plate which is connected to the shuttle extrusion 7707. There is also a cap with the screw hole and a screw can be used to tight the cap against the ball and the grooved plate to secure the laser in place. When the screw is loosened the laser can be adjusted to an appropriate angle to clearly illuminate the visualization area. Afterwards the screw is tightened to secure the laser.

In addition to the camera and light source features, FIG. 14A also illustrates the x encoder strip 1406. The strip 1406 is positioned on an extruder support beam that is behind the x extrusion guide guide 1410. The x encoder wiper assembly 1407 is positioned on the shuttle extrusion 7707 and the absolute position of the gantry head can be measured when the wiper 1407 is touching the encoder strip 1406.

FIG. 14B-E illustrates how the visualization configuration described in FIG. 14A can be used to quantify fluorescence abundance in microarray spots. FIG. 14B is representative image of microarray spots beside the laser beam. When the laser hits the surface the light dissipates the spots closer to the laser beam diameter 1408 are excited at a higher energy then the ones farther away. The object of the present invention is to both fabricate and analyze microarrays so its possible to know where these spots are and also know the appropriate location the laser diameter needs to be in order to excite these spots in a manner where they can be consistently measured. It is possible to measure multiple spots at the same time where the spots are evenly spaced from the laser beam diameter.

To quantify the fluorescence abundance from a microarray spot, a band pass filter is needed which is positioned in front of the camera that blocks all light except the wavelength energy which is emitted by the excited spots. This is shown in FIG. 14C where the laser beam diameter is marked for showing its position but is not visual because of the band pass filter. FIG. 14D illustrates how defined areas from the image can be grabbed so that the contained image pixels can be enumerated and quantified, FIG. 14E.

In addition to fluorescence microarray imaging, the camera can be configured to be synchronized with the dispenser. This is possible when the camera is triggered to take an image using an analog signal (like 3-5V). The microcontroller that generates the amplified waveform used for actuating the piezoelectric dispenser can also generate a signal to trigger the camera to take a photo at a defined time (ie., 2-500 microseconds) after the dispense event. This tool can be used to monitor dispensing at different target areas and also be used for kinetic measurements of chemical reactions such as what happens during DNA sequencing by synthesis reactions or by DNA sequencing by ligation as an example. It can be contemplated by one skilled in the art that this tool can be used to measure other enzymatic reactions and it is obvious that the camera and light source assembly can be configured to measure fluorescence. For example instead of a laser a timed flashing LED can be positioned near the surface from a structure positioned on the gantry and this light source can also be timed by the microcontroller that controls the dispenser.

### BRIEF DESCRIPTION OF THE DRAWINGS

FIG. 1A and 1B are two views of the bioprinter with the enclosure. FIG. 1A and 1B show how a syringe pump and 3 way valve is attached to the system. Also shown in FIG. 1A and 1B is the pressure compensation. Also pumps and bottles for the liquid handling wash station are shown.

FIG. 2 is an expanded view of the syringe pump and 3 way valve.

FIG. 3A, 3B and 3C are diagrams of the syringe pump assembly. FIG. 3A is a diagram that shows the syringe pump plate and how a linear guide is attached. FIG. 3B is a diagram showing how the stepper motor is attached to the plate and the position of the threaded rod. FIG. 3C is a diagram of the threaded nut coupler that attaches to the threaded rod. The threaded nut coupler is attached to the syringe plunger clip that is used to attach the plunger.

FIG. 4A, 4B and 4C are diagrams that show the 3 way valve assembly. FIG. 4A diagrams the bottom valve connector connected to the servo motor horn. FIG. 4A also diagrams how the servo is connected to an extrusion support connection plate. FIG. 4B is a diagram shows how a disposable stopcock valve handle is connected to the bottom valve connector. FIG. 4C is a diagram of the top valve connector and FIG. 4D shows how the stop cock valve base is connected to the top valve connector. FIG. 4E diagrams the complete 3 way valve assembly where the top valve connector is attached to the extrusion connection plate using a top valve connector support.

FIG. 5 is drawing showing an inside view of the bioprinter that shows the CoreXY cartesian gantry.

FIG. 6 are diagrams of the z directional bed assembly that consists of 2 z motors. FIG. 6A shows the left and right motor assembly. FIG. 6B diagrams the one side of the z directional bed assembly that identifies the support bed smooth rod, smooth rod support, threaded rod and the smooth rod bearinngs. FIG. 6C diagrams the z directional linear encoder. FIG. 6D diagrams the z encoder wiper that moves along the z directional linear encoder. The z encoder wiper is connected the movable platform.

FIG. 7A, 7B, 7C and 7D are diagrams that show the gantry shuttle assembly. FIG. 7A is a diagram of the basic shuttle consisting of a front slider plate, 3 wheels and a back slider plate without the extrusion which it rolls along. FIG. 7B shows the shuttle with the extrusion that moves along, this diagram also shows a front connection plate. The front connection plate is used to connect a z level sensor and linear actuator this is diagrammed in FIG. 7C. FIG. 7D is a diagram that shows how the linear actuator moves up and down using a described cable assembly.

FIG. 8A, 8B and 8C are diagrams that describe the linear encoder assembly that is used to track the position of the shuttle linear actuator described in FIG. 7C and 7D. FIG. 8A is a diagram of a plate that attaches the linear encoder strip and to an extrusion support. FIG. 8B shows the encoder strip and the linear actuator guide. FIG. 8C is a diagram of a shuttle that includes a wiper that travels along the encoder strip as the shuttle moves when connected to the other end of the same cable diagrammed in FIG. 7D.

FIG. 9A, 9B and 9C are diagrams that show how the motor assembly that is used to move the cable diagrammed in FIG. 7D and FIG. 8C, the motor is mounted is in between the cable ends and moves the cable. FIG. 9A shows the motor mount that attaches the motor to an extrusion support. FIG. 9B shows the motor attached to the motor mount. FIG. 9C shows the complete assembly for moving the cable FIG. 10 diagrams the motor mount assembly diagrammed in FIG. 9C and the linear encoder assembly for the gantry shuttle linear actuator diagrammed in FIG. 8D.

FIG. 11A, 11B, 11C and 11D are diagrams that describe the conveyor process that demonstrates how to convert the bioprinter into a high throughput system. These FIGS. are viewed as a sequence with FIG. 11A being the first step in the process and FIG. 11D being the last step. These figures show 4 conveyor assemblies.

FIG. 12A, 12B and 12C are different perspective views of one of the conveyor assemblies. FIG. 12A is a diagram to shows how the conveyor shuttle is attached to a conveyor bed. FIG. 12B is a diagram that shows how the conveyor is attached to a threaded rod and how it rolls along the extrusion support using an attached wheel. The threaded rod is attached to a motor. FIG. 12C is diagram of the underside of the conveyor bed to show how the conveyor bed is attached to a conveyor bed shuttle.

FIG. 13A is a diagram showing a top down view of the movable platform that includes a sample source plate, wash station, droplet viewing area and an extrusion that used for rolling conveyor beds onto the platform. FIG. 13B is a diagram that demonstrates how a droplet can be visualized in flight before hitting the target surface. FIG. 13C is a diagram showing how deflected droplets can be collected. FIG. 13D shows what an example droplet image looks like.

FIG. 14A is a diagram showing how a camera and laser can be mounted on the gantry shuttle. FIG. 14B, 14C, 14D and 14E is a diagram explaining how the bioprinter can be used as a fluorescence imager.

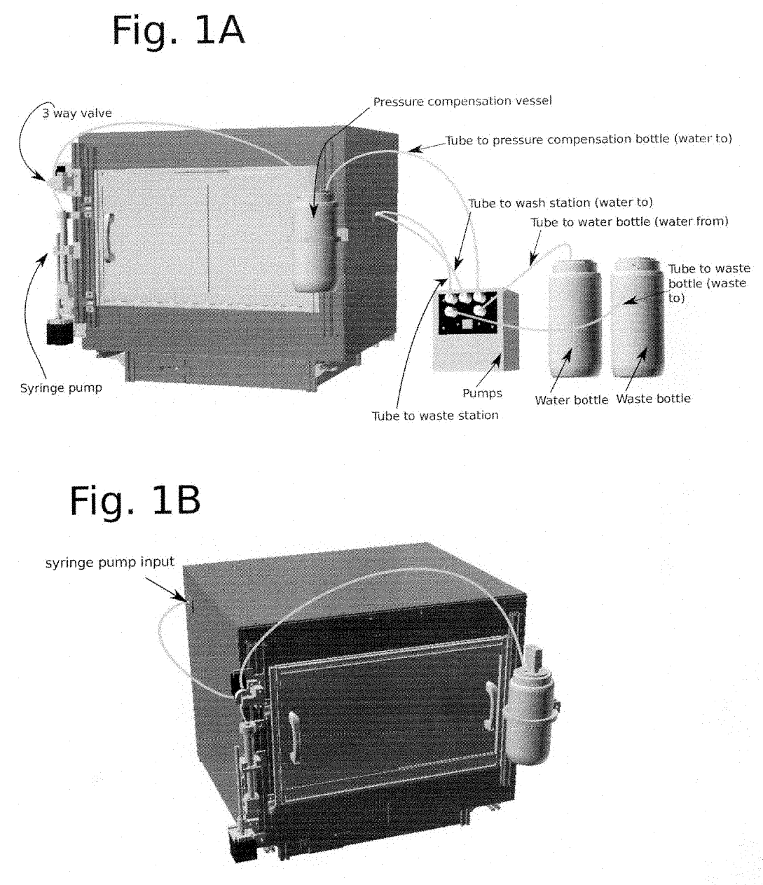

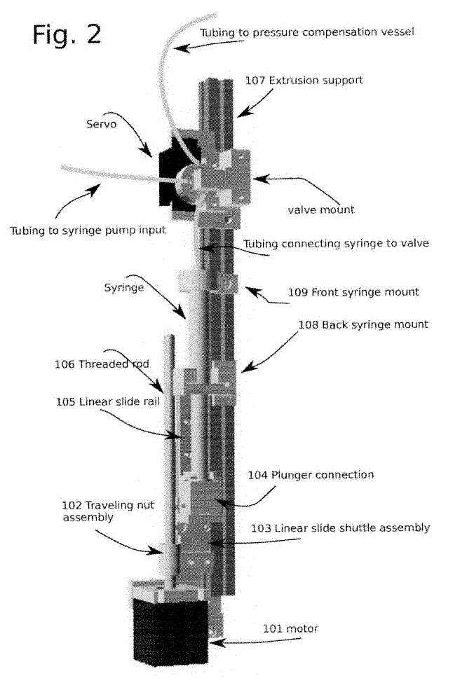

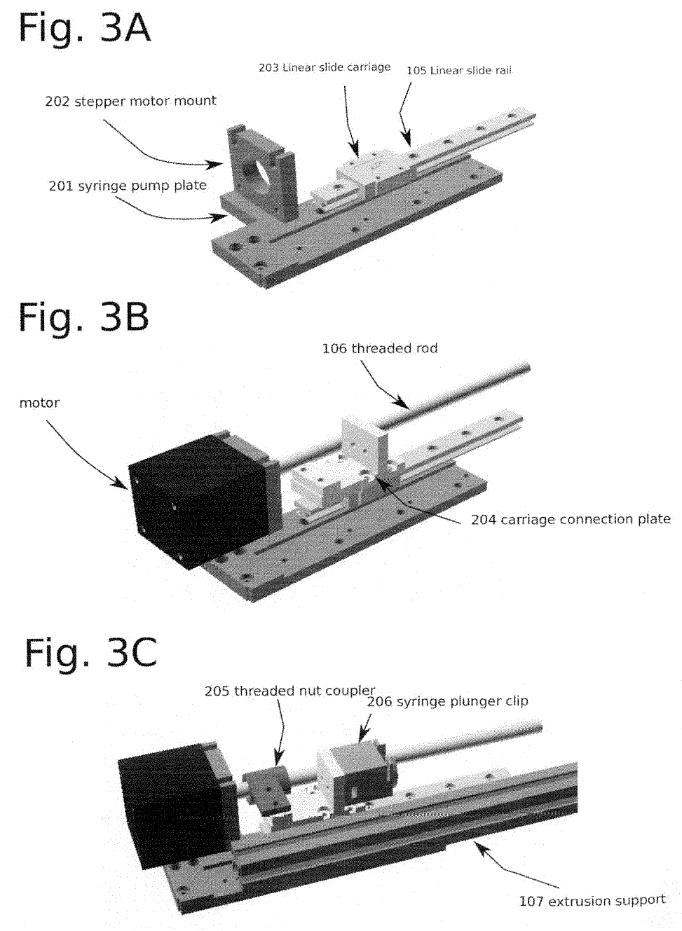

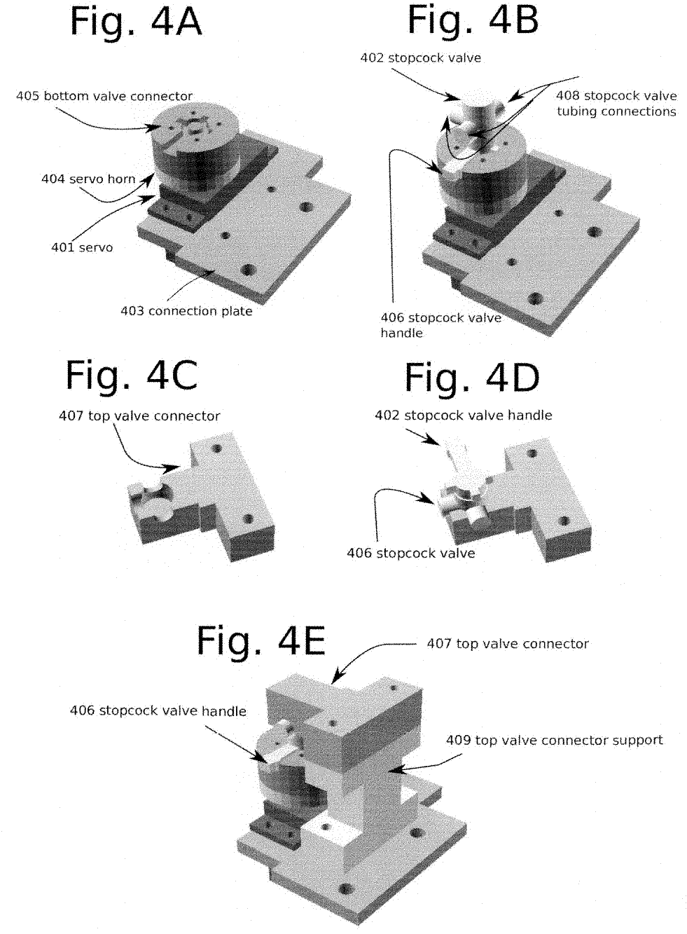

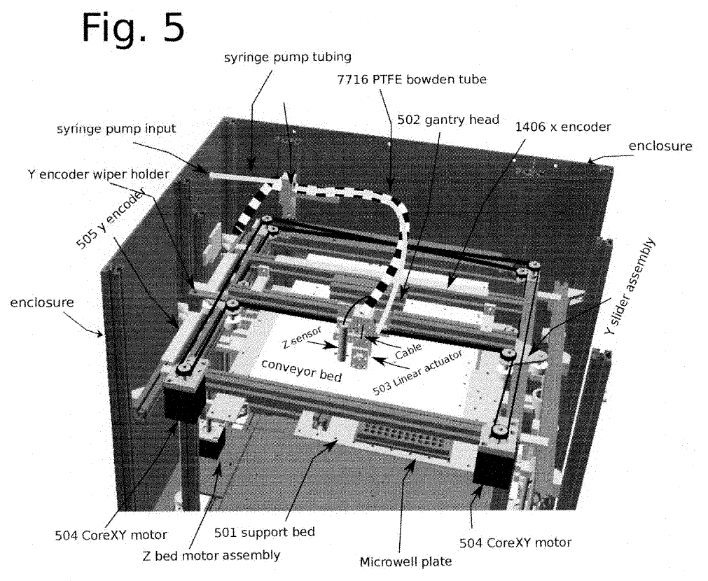

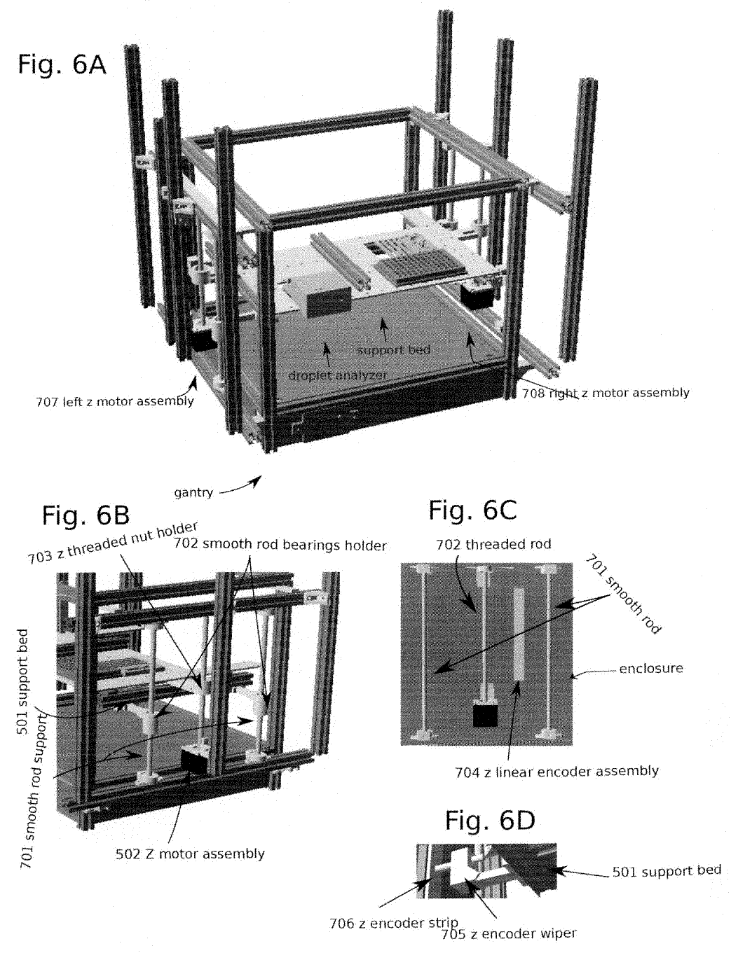

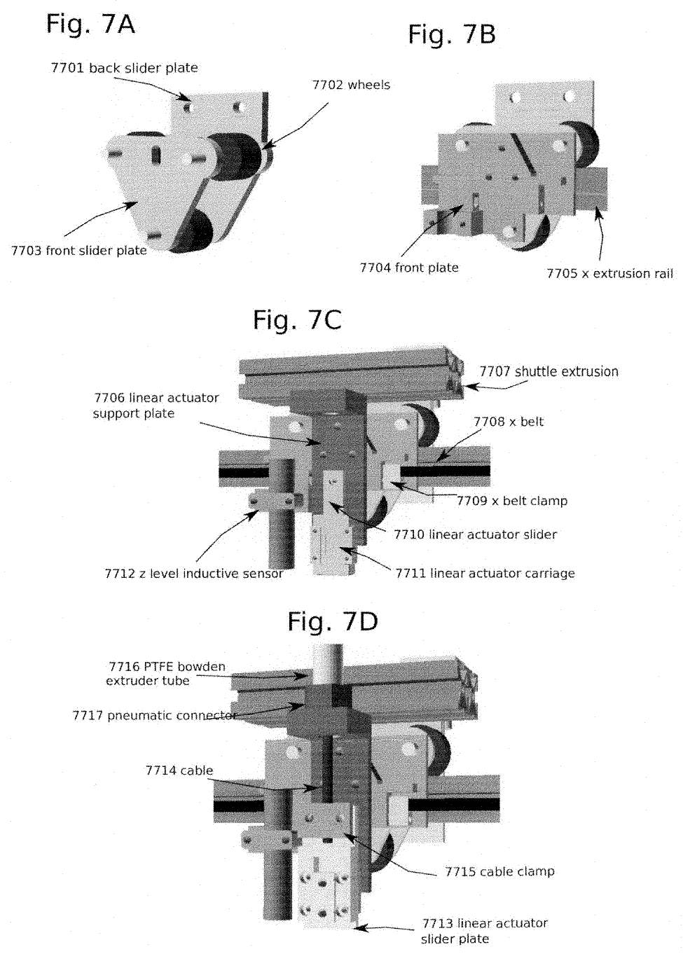

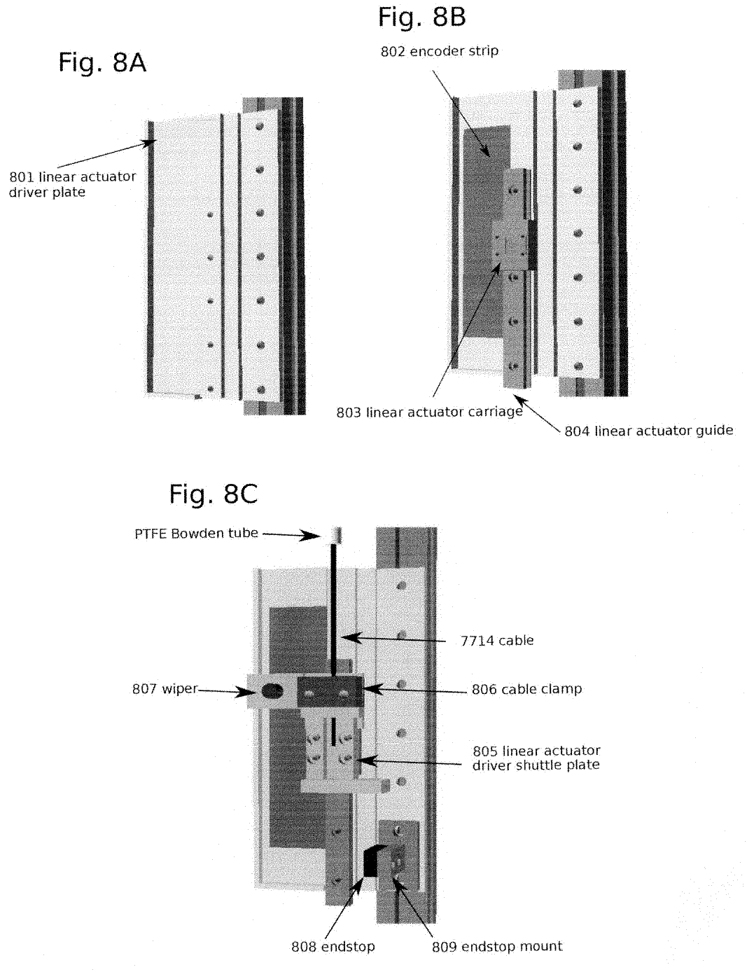

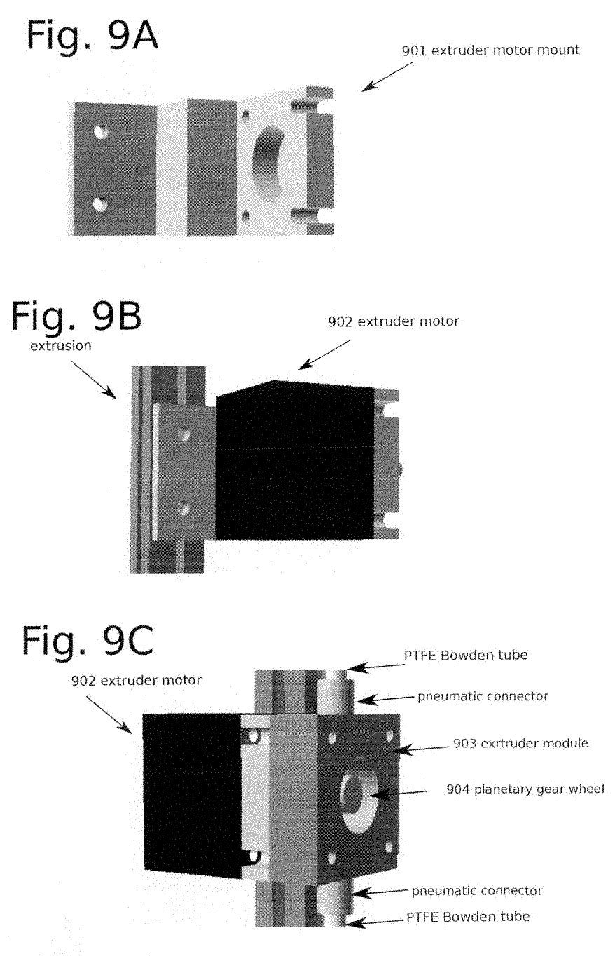

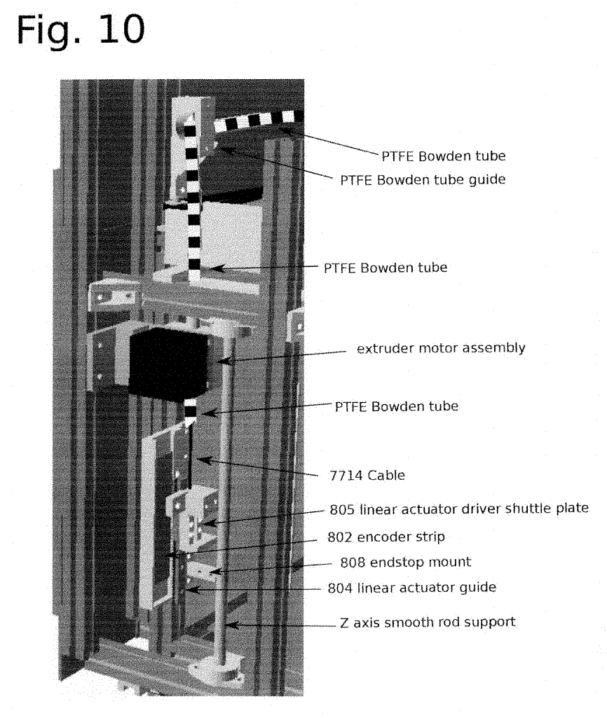

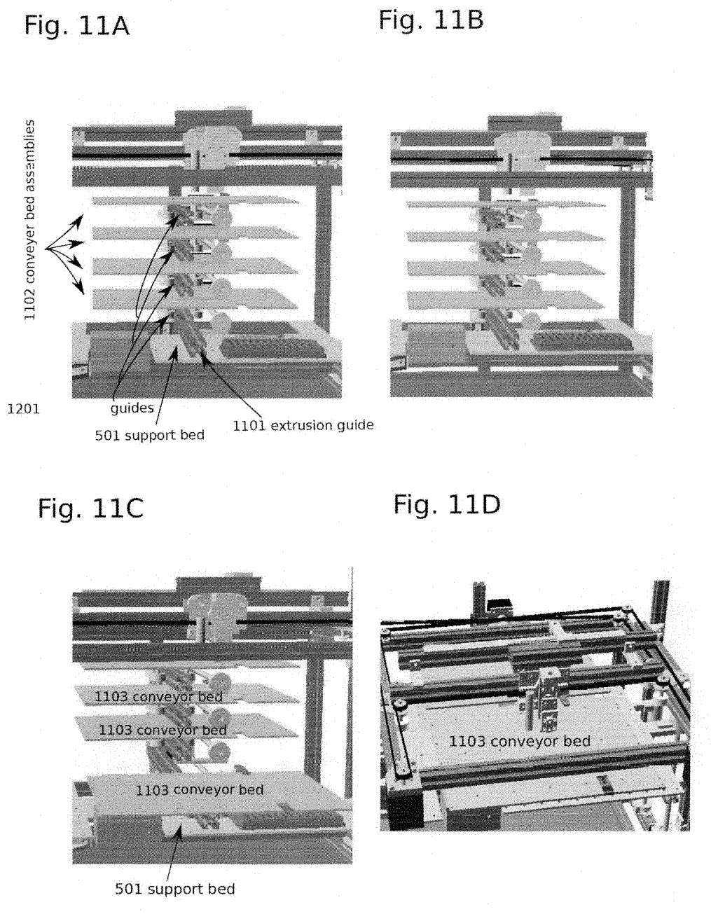

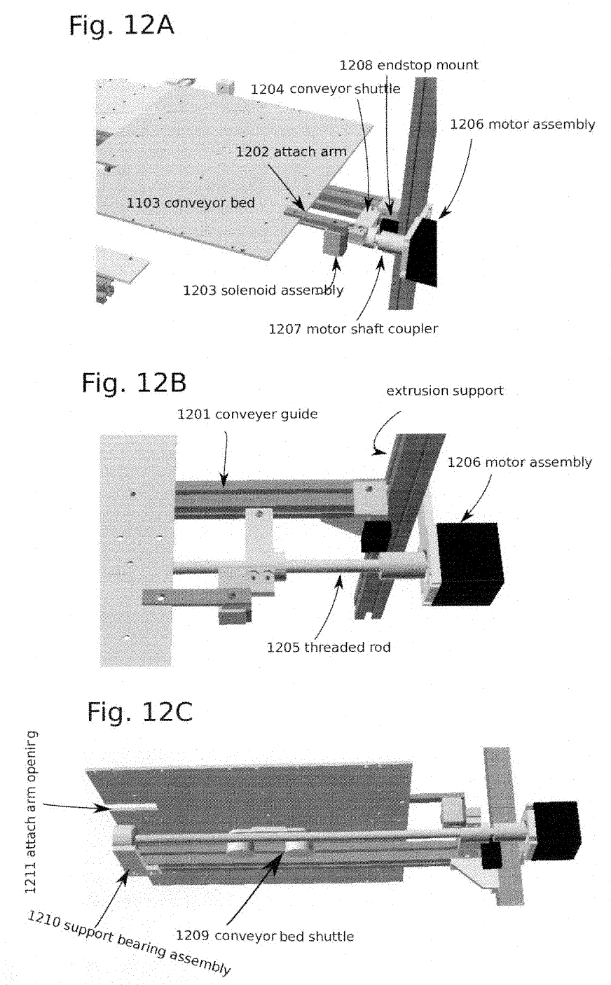

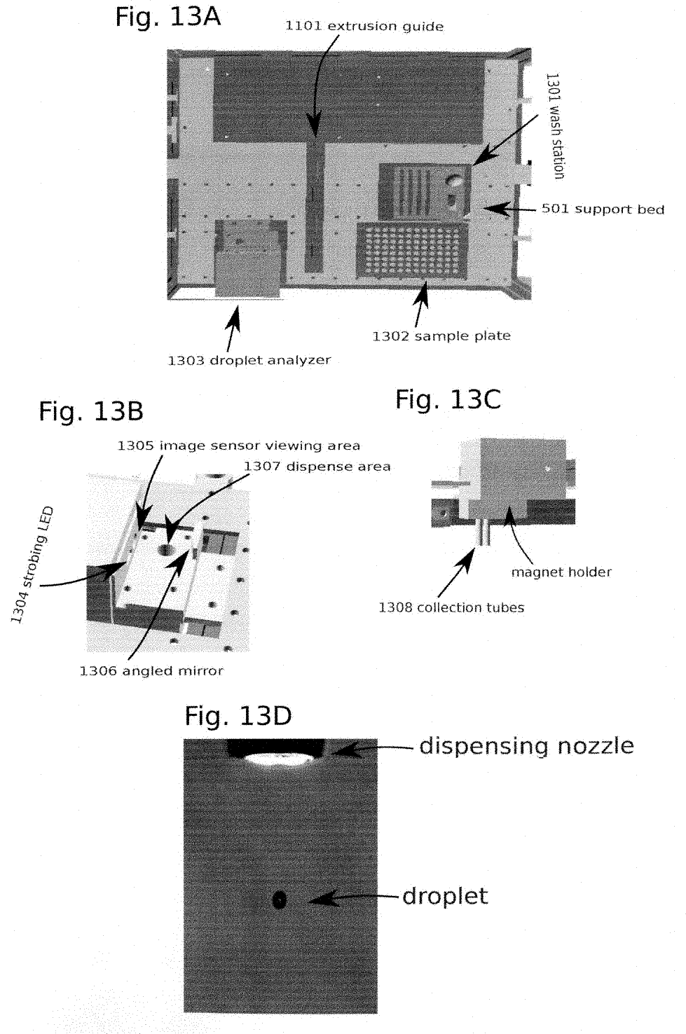

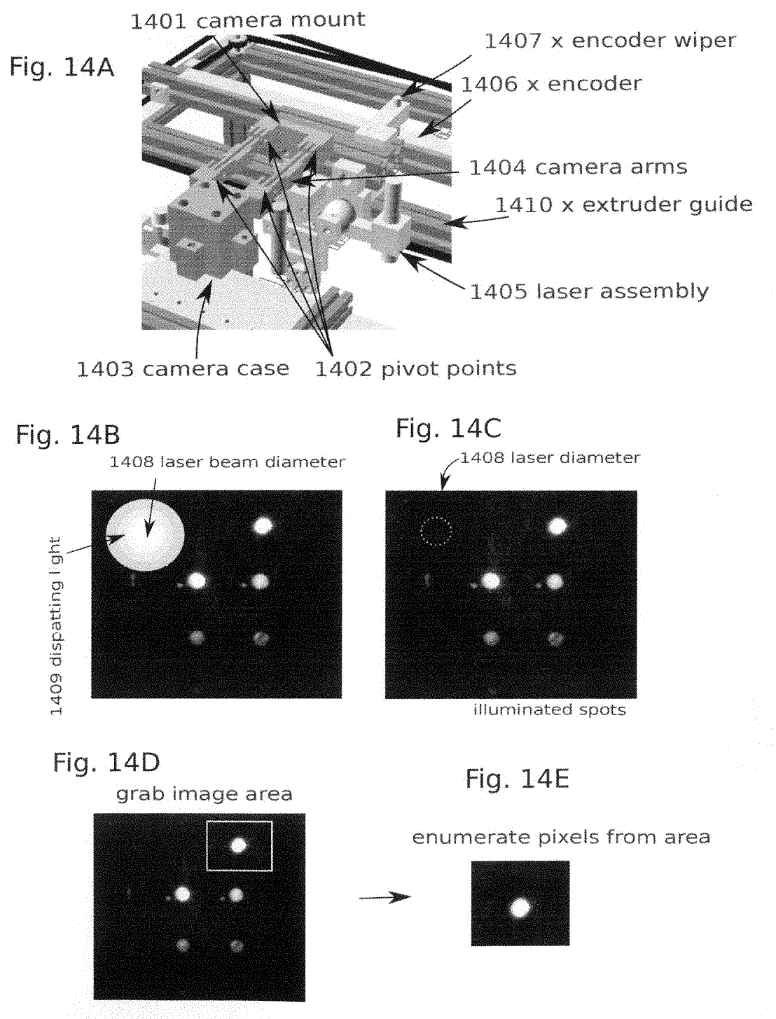

I claim:

1. A gantry enabling motion in X, Y and Z direction comprising
a X directional support rail,
two Y directional support rails,
Z support rails,
Z conveyor assembly for high throughput,
X position gantry shuttle,
Y position gantry shuttles,
a modular platform that moves in the Z direction,
a X directional linear encoder,
a Y directional linear encoder,
telescoping linear actuator modules,
syringe pump modules,
fluorescence imager modules positioned on the X position gantry shuttle and droplet detector modules.

2. The Z conveyor assembly in claim 1, consisting of
a vertical support that is attached to the gantry to allow for conveyor beds to be moved onto the modular platform,
a stepper motor that is attached to a threaded rod,
an electrical switch connected to a support beam,
a conveyor shuttle having a means to connect a wheel that rolls along an extrusion on the support beam,
the conveyor shuttle also has a means to connect to a threaded rod,
a conveyor bed shuttle that rolls along the support beam using wheels,
and the conveyor bed that connects to the conveyor bed shuttle.

3. The X directional linear encoder in claim 1, comprising
an X directional encoder support,
a linear encoder strip,
X directional encoder support brackets that are connected to the gantry X directional support rail,
a X directional encoder wiper mount connected to the gantry shuttle that is used to adjust the height of a X encoder wiper using a hole that fits the X encoder wiper that consists of a threaded rod allowing for height adjustment.

4. The Y directional linear encoder in claim 1, comprising a Y directional encoder support, said linear encoder strip,
Y directional encoder support brackets that connect to the gantry Y support rail,
a Y encoder wiper mount connected to said Y shuttle using a hole that fits the y encoder wiper that consists of a threaded rod that allows for height adjustment.

5. The syringe pump module in claim 1, comprising
a syringe pump module extrusion support,
a servo motor,
servo to extrusion support connector,
servo horn to stop cock valve connector,
a stop cock valve handle to said syringe pump module extrusion support,
a stop cock valve,
a syringe,
a stepper motor,
a connector that attaches the stepper motor to the syringe pump module extrusion support,
a threaded rod,
a connection means for attaching the threaded rod to the stepper motor,
a syringe plunger linear actuator shuttle,
a syringe plunger linear actuator shuttle slide,
a connection means for attaching the barrel of the syringe to said syringe pump module to the extrusion support,
a connection means for attaching the syringe plunger handle to the syringe plunger linear actuator shuttle.

6. The fluorescence imager module in claim 1, consisting of
a camera positioned on the gantry X shuttle,
a lens positioned on the gantry X shuttle,
a laser positioned on the gantry X shuttle,
and a wavelength band pass filter mount on the fluorescence imager lens that obstructs the laser light and passes through emitted fluorescence light to the camera.

7. The telescoping linear actuator modules in claim 1, comprising
a cable,
a connection means of attaching the stepper motor to the gantry,
a planetary gear wheel attached to the stepper motor spindle for moving the cable,
an extruder module connected to the stepper motor having top and a bottom
tubing connection means where the tubing has a inner diameter wide enough for the cable to pass through,
a connection means for attaching a linear slide and linear encoder strip to the gantry,
a linear slide shuttle that connects to the cable using a clamp that moves in an up and down direction along the linear slide,
an end stop connection means that is positioned at the bottom end of the linear slide that is used for homing the telescoping linear actuator,
a linear slide positioned on the gantry X shuttle,
a linear slider shuttle that moves in a up and down direction along the linear slide,
and a connection means for attaching the cable to the X shuttle linear slide shuttle.

8. The droplet detector module in claim 1, consisting of
a camera,
a lens,
an illumination source that can be controlled by an analog signal,
a dispenser that dispenses upon actuation from an analog signal,
a computer processing unit for controlling the off and on timing
the illumination source and the dispenser in microseconds,
a collection chamber that the dispenser dispenses into, said collection
chamber can be an electrical charge.

9. The droplet detector module in claim 1, consisting of
a camera that can be trigger to take a photo by an analog signal,
a lens attached to the camera,
a dispenser that dispenses upon actuation from an analog signal,
a computer processing unit for controlling the dispenser and camera where photos can be
taken within microseconds after dispensing.
